(19) United States
(12) Patent Application Publication
(10) Pub. No.: US 2025/0178859 A1
(43) Pub. Date: Jun. 5, 2025

(54) ANTI-THEFT CABLE STORAGE SYSTEM

(71) Applicant: Hubbell Incorporated, Shelton, CT (US)

(72) Inventors: Scott Roger KLAWITTER, Beaver Dam, WI (US); Brett Anthony KNUTSON, West Bend, WI (US)

(21) Appl. No.: 18/969,818

(22) Filed: Dec. 5, 2024

Related U.S. Application Data
(60) Provisional application No. 63/606,329, filed on Dec. 5, 2023.

(51) Int. Cl. B65H 75/36; B60L 53/18; B60L 53/31

(52) U.S. Cl. CPC B65H 75/362; B60L 53/31; B60L 53/18; B60L 2270/34; B65H 2701/34

(57) ABSTRACT

A cable storage system including a housing having a top portion, a bottom portion, and an opening, a drive pulley within the top portion of the housing, a cable at least partially contained in the housing having a proximal end in the housing and a distal end outside of the housing, the cable extending over the drive pulley and through the opening, and a motor driving the drive pulley to extend or retract the cable via the opening in response to a signal. The bottom portion of the housing is sized to permit the cable, in a retracted configuration, to hang in the bottom portion of the housing.

### FIELD OF THE INVENTION

The present disclosure relates to cable storage systems, and more particularly, to anti-theft cable storage system for use with electric vehicle charging stations and other applications.

### BACKGROUND

As the number of electric vehicles (EV) on the road continues to increase, there is a need to expand the charging infrastructure. State and local governments are installing charging stations for public use. EV chargers are also being installed at business locations and private residences, often outdoors.

The current EV charging solutions in the field, both public and restricted access, can leave the charging cable exposed. The cables have a high percentage of copper within the length of the cable. This has led to acts of vandalism and theft as criminals are cutting the EV charging cables to obtain and sell the copper residing within. The cables are expensive and often have significant lead time restrictions associated with procurement. There is a need to restrict access to the EV charging cable to reduce the likelihood of the cables being stolen.

There are solutions to raise the EV charging cable up and out of reach when not being used. Raising the cable up does not completely restrict individuals from accessing the cable, but simply makes it more difficult in hopes to defer theft efforts. Also, most public EV chargers are located where an overhead structure is not available to mount a cable dispenser. Many EV chargers are located on the ground floor, with the EV cable stemming directly from the user interface. There are also solutions in which the EV charging cable is spooled within an enclosure but this can lead to overheating of the cable.

There is a need for improved means for electrical cable management for EV's and other applications.

### SUMMARY

An object of the present invention is to provide a system in which the cable is within an auxiliary enclosure when not in use.

The cable storage system according to the present disclosure advantageously secures the EV charging cable within an auxiliary enclosure when the cable is not being used, disallowing the general public's access to the cable. By removing the exposed EV charging cable until user validation is entered, acts of vandalism and theft aimed at stealing/damaging the cable are significantly more difficult. The system protects the high value EV charge cable, deferring and eliminating the ease associated with stealing the cable in previous charging solutions.

In one exemplary embodiment, a cable storage system is provided, including a housing having a top portion, a bottom portion, and an opening, a drive pulley within the top portion of the housing, a cable (e.g., electric vehicle charging cable) at least partially contained in the housing having a proximal end in the housing and a distal end outside of the housing, the cable extending over the drive pulley and through the opening, and a motor driving the drive pulley to extend or retract the cable via the opening in response to a signal. The bottom portion of the housing is sized to permit the cable, in a retracted configuration, to hang in the bottom portion of the housing, e.g., without spooling. In some embodiments, the cable 120 may at least partially lay on the bottom portion of the enclosure.

In some embodiments, the signal is indicative of a user validation and/or includes a validation of a payment method.

In some embodiments, the system includes a first frame member and a second frame member, wherein the drive pulley is rotatably secured between the first and second frame members. The motor may be secured on an exterior of one of the first frame member or the second frame member. The housing may include a cable head pocket including the opening, e.g., attached to the first and second frame members.

In some embodiments, the system includes a plurality of pinch rollers adjacent to the drive pulley, wherein the cable extends between the plurality of pinch rollers and the drive pulley. Each of the plurality of pinch rollers may have an axle positioned in a first slot in the first frame member and a second slot in the second frame member, the axle being biased in a direction towards the drive pulley by a spring.

In some embodiments, the system further includes an idler pulley rotatably secured in the housing, wherein the cable extends at least partially around the idler pulley. The idler pulley may be positioned forward of the drive pulley in the housing, e.g., to route the cable toward the front of the housing. In other embodiments, the system may include a guide for the cable including an elongated channel for the cable.

Further provided is an electric vehicle charging system, including a terminal including a power supply and at least one input device for receiving input from a user; and a cable storage system including a housing having a top portion, a bottom portion, and an opening; a drive pulley within the top portion of the housing; the charging cable at least partially contained in the housing having a proximal end attached to the power supply and a distal end outside of the housing, the charging cable extending over the drive pulley and through the opening; and a motor driving the drive pulley to extend or retract the charging cable via the opening in response to a signal from the terminal. In some embodiments, the bottom portion of the housing is sized to permit the cable, in a retracted configuration, to hang in the bottom portion of the housing.

Further provided is a drive system for a cable, including a first frame member, a second frame member, a drive pulley rotatably secured between the first and second frame members and configured to receive the cable, a plurality of pinch rollers rotatably secured between the first and second frame members adjacent to the drive pulley, each of the plurality of pinch rollers being spring-biased toward the drive pulley, a motor attached to one of the first or second frame members for driving the drive pulley, and a sensor for determining a position of the drive pulley.

In some embodiments, each of the plurality of pinch rollers has an axle positioned in a first slot in the first frame member and a second slot in the second frame member, the axle being biased in a direction towards the drive pulley by a spring.

In some embodiments, the sensor is an encoder on an axle of the drive pulley. The encoder may be, for example, an absolute encoder. In some embodiments, the system includes a count plate rotatable coaxially with the drive pulley, the count plate having a plurality of teeth about a circumference of the count plate, wherein the sensor is a proximity sensor mounted adjacent to the circumference of the count plate. The proximity sensor may be, for example, an inductive proximity sensor.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is an isometric view of electric vehicle charging system according to an exemplary embodiment of the present disclosure;

FIG. 2 is an isometric view of the cable storage system according to an exemplary embodiment of the present disclosure;

FIG. 3 is a front view of the cable storage system shown in FIG. 2;

FIG. 4 is a side view of the cable storage system shown in FIG. 2 with an exterior panel removed;

FIG. 5 is a top view of the cable storage system shown in FIG. 2 with an exterior panel removed;

FIG. 6 is an isometric view of the cable storage system shown in FIG. 2 in a partially disassembled state with external housing components removed;

FIG. 7A is an isometric view of the cable storage system shown in FIG. 2 with external housing components removed;

FIG. 7B is an isometric view of the cable storage system shown in FIG. 2 with external housing components removed;

FIG. 8 is another isometric view of the cable storage system shown in FIG. 2 with external housing components removed;

FIG. 9 is an isometric view of a drive assembly of a cable storage system according to an exemplary embodiment of the present disclosure;

FIG. 10 is a side view of the drive assembly shown in FIG. 9;

FIG. 11 is another side view of the drive assembly shown in FIG. 9;

FIG. 12 is an isometric view of the drive assembly shown in FIG. 9 with external housing components removed; and

FIG. 13 is a side view of a count plate and position sensor of the drive assembly shown in FIG. 9.

### DETAILED DESCRIPTION

The present disclosure may be understood more readily by reference to the following detailed description of the disclosure taken in connection with the accompanying drawing figures, which form a part of this disclosure. It is to be understood that this disclosure is not limited to the specific devices, methods, conditions, or parameters described and/or shown herein, and that the terminology used herein is for the purpose of describing particular embodiments by way of example only and is not intended to be limiting of the claimed disclosure.

Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure.

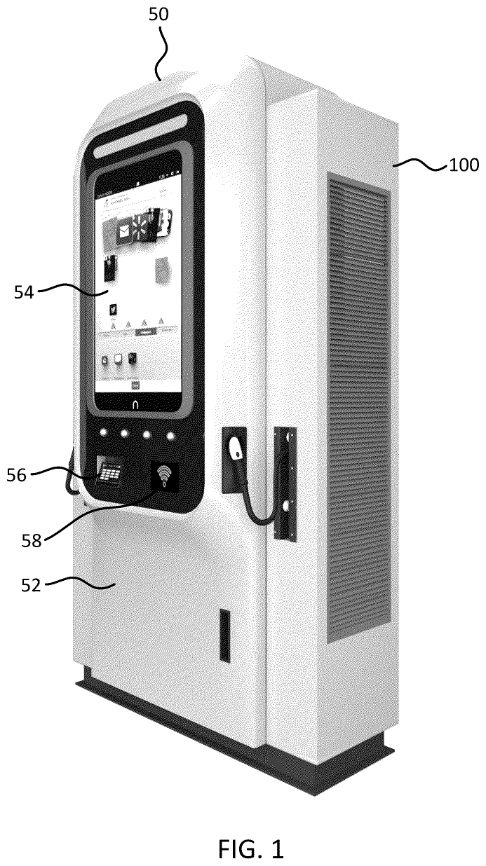

FIG. 1 show an electric vehicle charging system according to an exemplary embodiment of the present disclosure. The charging system includes a terminal 50 including a housing 52 and a display 54. The display 54 may be an interactive display with a touchscreen interface for receiving user inputs. The terminal 50 may further include one or more input devices such as a keypad 56 and/or a wireless (e.g., NFC) payment device 58.

The electric vehicle charging system is configured to receive an input (e.g., a selection, entry of information, credentials, payment, etc.) from a user via the display 54, keypad 56, and/or the wireless payment device 58. Upon receiving and validating a user input, a cable storage system 100 is activated to release a cable and enable charging of an electric vehicle. The cable storage system 100 may be attached to and operable with one terminal 50 as shown and/or to a plurality of adjacent terminals 50.

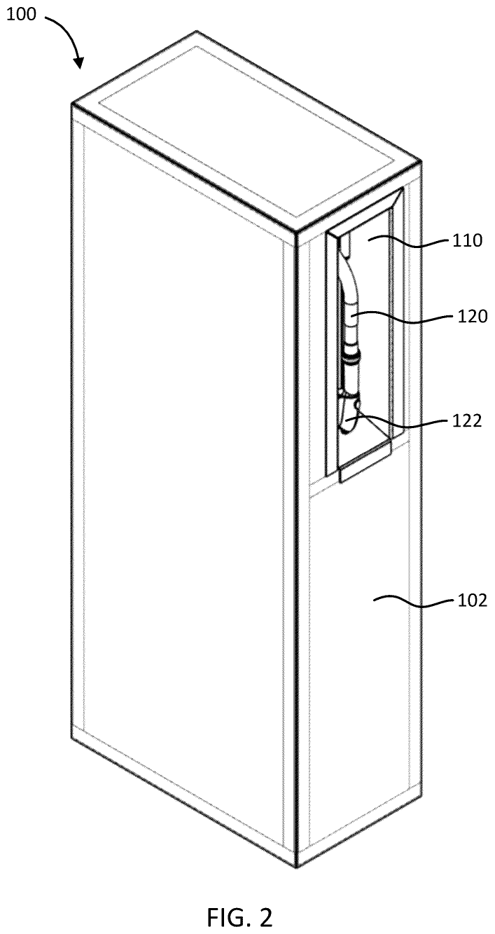

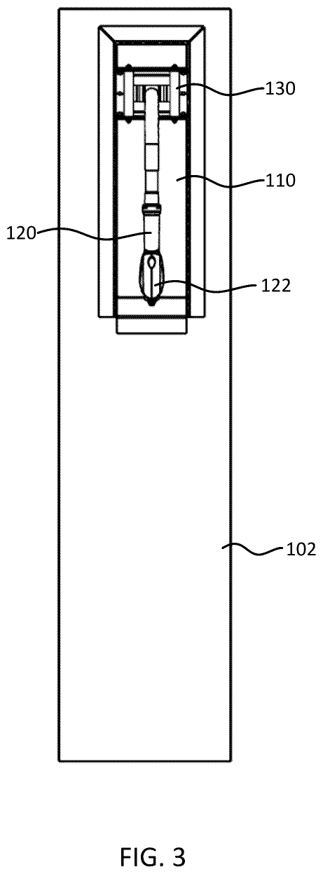

FIG. 2 is an isometric view of a cable storage system 100 according to an exemplary embodiment of the present disclosure and FIG. 3 is a front view of the cable storage system 100. The system 100 includes a housing 102 (e.g., auxiliary enclosure) which may comprise a plurality of housing panels. In the exemplary embodiment, the housing 102 has a rectangular cross-section. In some embodiments, the housing 102 includes a vent as shown in FIG. 1, e.g., for dissipation of heat from the cable 120.

The housing 102 includes a cable head pocket 110 through which the cable 120 is retracted and extended. The cable head pocket 110 provides a protected space for the distal end of the cable 120. The distal end of the cable 120 has a charging adapter 122 on its distal end. The adapter 122 may, for example, be a J1772 adapter, a Telsa (J3400) adapter, and any other adapter for charging electric vehicles. The adapter 122 is within the cable head pocket 110 when not in use and protected from the weather. In some embodiments, the cable head pocket 110 includes a socket for receiving the adapter 122.

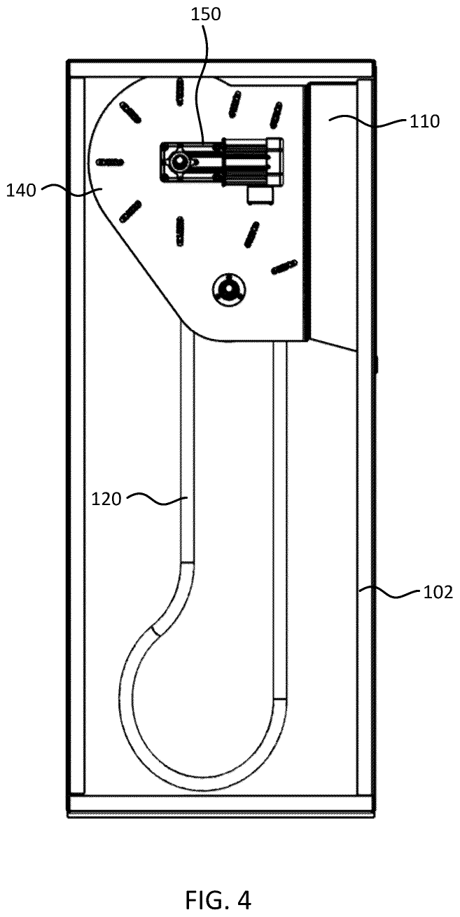

FIG. 4 is a side view of the cable storage system 100 with a side exterior panel of the housing 102 removed. This is for illustrative purposes only. Preferably the exterior panels of the housing 102 are not readily removable. For example, some of the panels may have a lock and/or some of the panels may be non-removable to restrict access to the interior of the housing 102.

The housing 102 has a top portion including a drive assembly, a bottom portion below the drive assembly for receiving the cable 120 when retracted, and at least one opening for the cable 120 to exit the housing 102. The drive assembly of the cable storage system 100 includes one or more frame members 140,142 and a motor 150. In the exemplary embodiment, the housing 102 has a height sufficient to enable the cable 120 to hang freely in the bottom portion, e.g., without spooling and/or laying on a bottom surface of the housing 102. However, in some embodiments, the cable 120 may at least partially lay on the bottom portion of the enclosure. The cable 120 drops down within the housing 102 from the drive assembly and loops back up to a proximal end, e.g., in the top portion of the housing 102, where it connects to the terminal 50 and/or power supply. The loop has enough slack to allow for the necessary cable travel for a given application. Though the proximal end of the cable 120 is shown in the top portion of the housing 102, the proximal end may be at or near the bottom, middle or any desired location in the housing 102. In some embodiments, the proximal end of the cable 120 is positioned towards the bottom of the housing 102 and the cable 120 extends up towards the top the housing 102 before hanging down. This configuration avoids the need to spool the cable 120 or use a slip ring, both of which can lead to heat mitigation problems.

The cable storage system 100 includes a controller (e.g., within a housing of the motor 150) for operating the motor 150 to extend and retract the cable 120. The controller further operates the motor 150 and/or a brake or similar apparatus to restrict the cable 120 from being extracted from the housing 102. The controller is in wired or wireless communication with the terminal 50 to receive a signal when an authorized user input, e.g., valid credentials/payment, is provided. The brake or similar apparatus releases and allow for the cable 120 to be extracted from the housing 102 for charging. Once charging is finished, the controller receives a signal from the terminal instructing it to operate the motor 150 to retract the cable 120 back into the housing 102 and engage the brake or similar apparatus until the next authorized use.

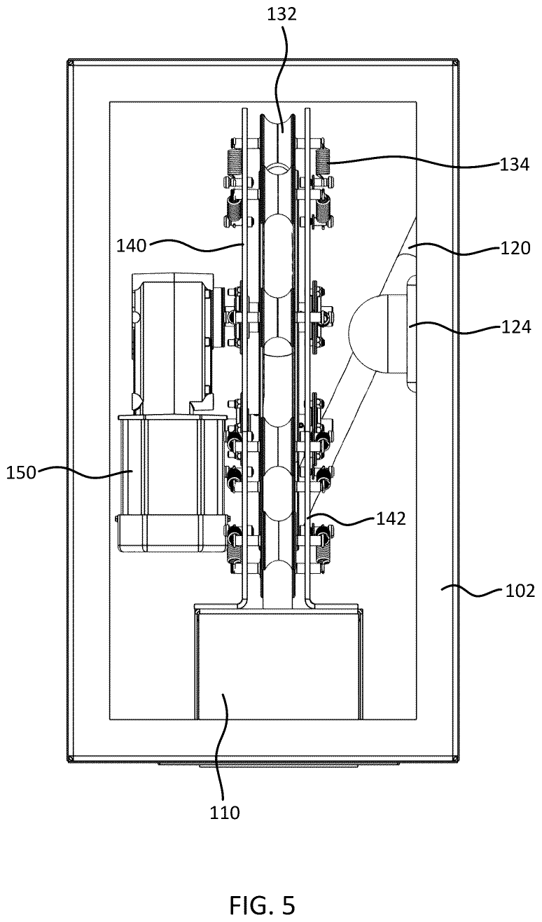

FIG. 5 is a top view of the cable storage system 100 with a top exterior panel of the housing 102 removed. The frame members 140,142 may be attached to the cable head pocket 110, e.g., by fasteners, or formed integrally therewith. A plurality of pulleys and/or rollers are rotatably secured between the frame members 140,142. As shown in FIG. 5, a plurality of pinch rollers 132 are secured between the frame members 140,142. At least some of the pinch rollers 132 may be biased towards a drive pulley 136 with springs 134.

The pinch rollers 132 being biased toward the drive pulley 136 with springs 134 allows for different sized cables to be used. For example, the present invention is particularly useful for level 3 EV chargers. The diameter of the cable used for level 3 EV chargers is typically greater than the diameter for level 2 EV chargers. The diameters may also vary, e.g., depending on the needs of the user. The present invention can accommodate different sized cables without having to change the pulleys or rollers.

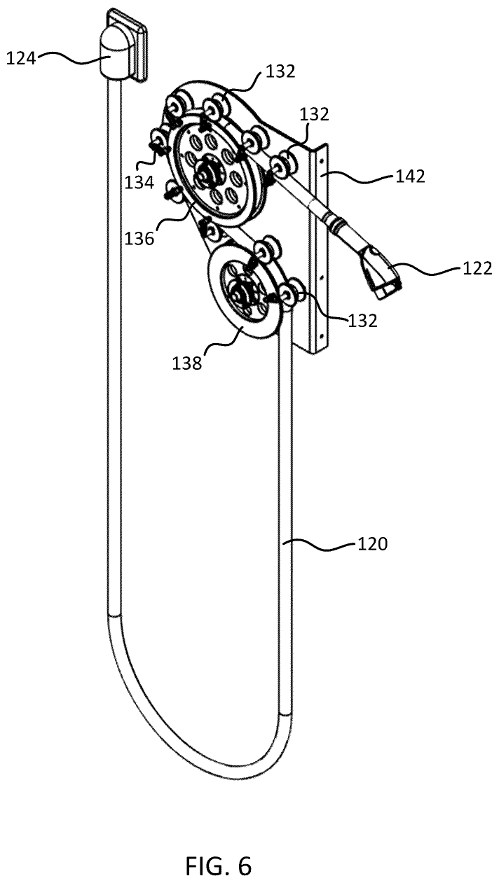

FIG. 6 is an isometric view of the cable storage system 100 in a partially disassembled state with the housing 102 and frame member 140 removed for illustration purposes. The system 100 includes a drive pulley 136 rotatably mounted between the frame members 140,142 and driven about an axle or shaft by the motor 150. An idler pulley 138 may be included adjacent to the drive pulley 136. In the exemplary embodiment, the idler pulley 138 is offset forward of the drive pulley 136 to direct the cable 120 toward the front of the housing 102. Pinch rollers 132 may be positioned around the drive pulley 136 and/or the idler pulley 138 to guide and/or tension the cable 120. A proximal end of the cable 120 is secured at an attachment point in a top portion of the housing 102. In the exemplary embodiment, the proximal end includes a connector 124 secured to an opening in one of the housing panels to connect the cable 120 to a power supply in an adjacent terminal 50.

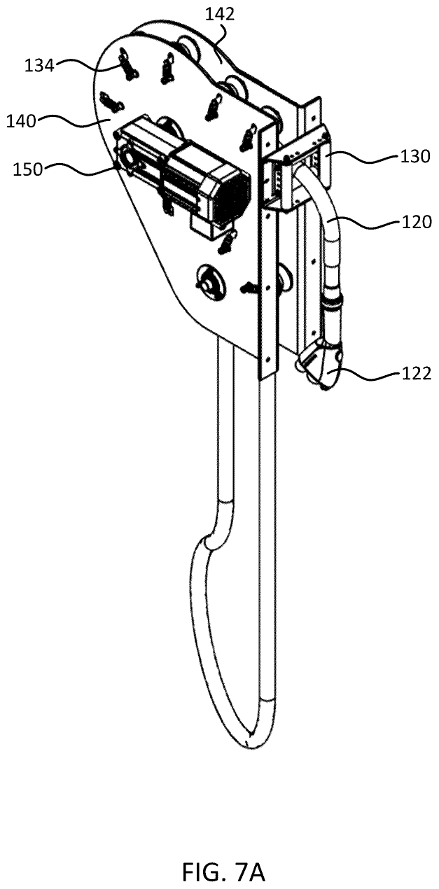

FIGS. 7A and 7B are isometric views of the cable storage system 100 with external housing components removed. The cable 120 is shown in a retracted configuration. During down-times when the equipment is not being used, the cable 120 is retracted and kept inside of the housing 102. The motor 150, a brake, or other similar apparatus prevents the cable 120 from being pulled out. As shown in FIGS. 7A and 7B, the pinch rollers 132 have axles or shafts positioned in slots in the frame members 140,142 allowing the pinch rollers 132 to slide toward and away from the drive pulley 136 and/or idler pulley 138 and being biased by springs 134. The pinch rollers 132 act as a support to push/pull the cable 120 into/out of the housing 102. The system 100 may further include a cable guide assembly 130 with one or more rollers.

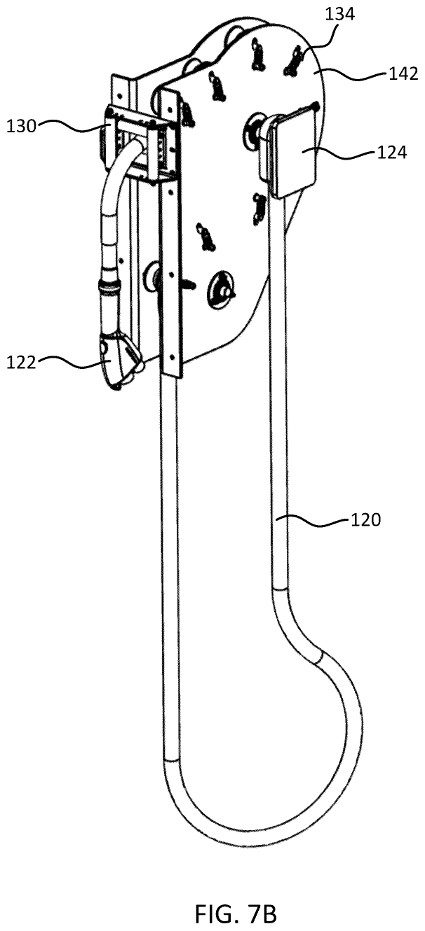

FIG. 8 is another isometric view of the cable storage system 100 with external housing components removed. The cable 120 is shown in an at least partially extended configuration. Different cable lengths may be provided to accommodate different charger locations and configurations. When longer cable lengths are used, the housing 102 may be taller to allow the cable 120 to hang without spooling. Alternatively, a different quantity and/or different sizes of drive and/or idler pulleys may be employed to limit excess slack of cable 120 in the housing 102. In some embodiments, the cable storage system 100 includes two or more adjacent cables with respective drive systems in the same housing and connected to the same or different terminals 50.

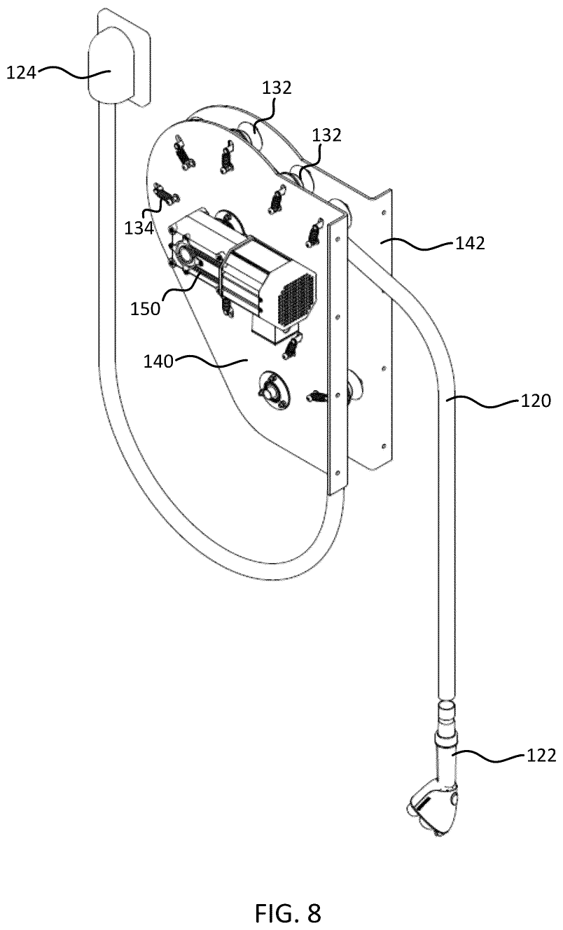

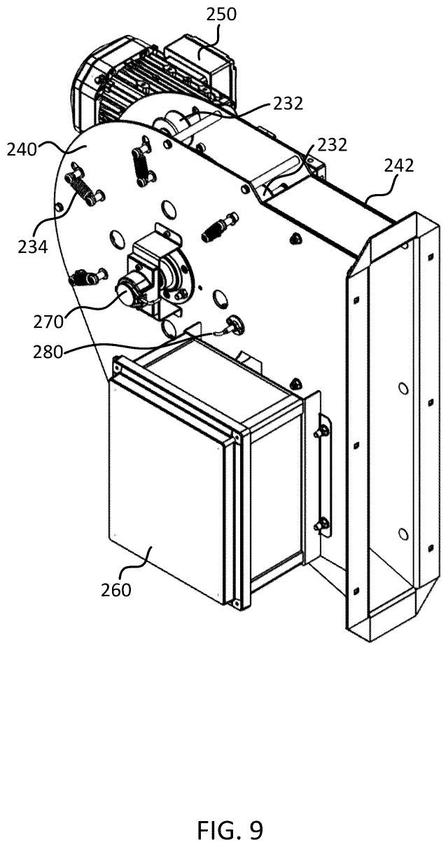

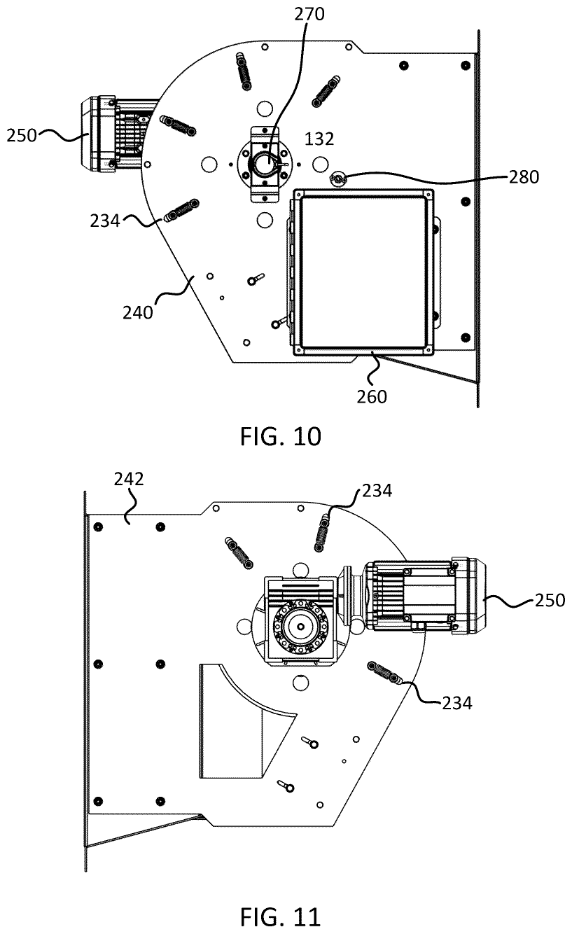

FIG. 9 is an isometric view of a drive assembly of a cable storage system according to an exemplary embodiment of the present disclosure. FIGS. 10-11 are side views of the drive assembly shown in FIG. 9. Except as described herein, the drive assembly of FIG. 9 shares the same components and features of the drive assembly shown in the previous figures. The drive assembly shown in FIG. 9 may be used in the housing 102 and/or with the terminal 50 as described above. The drive assembly may also receive a cable, such as the cable 120 with the adapter 122.

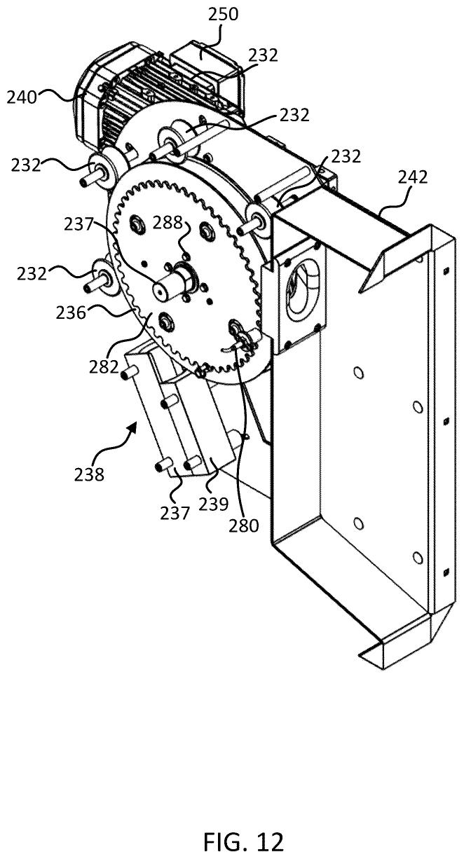

The drive assembly includes one or more frame members 240,242, a drive pulley 236 (see FIG. 12), and a motor 250 mounted on the frame assembly 242. A plurality of pinch rollers 232 are also secured between the frame members 240,242. At least some of the pinch rollers 232 are biased towards the drive pulley 236 with springs 234. The drive assembly further includes a control assembly 260 mounted on the frame member 240. The control assembly 260 may include a controller (e.g., processor) and a non-transitory storage medium including software executing on the controller.

The control assembly 260 operates the motor 250 to extend and retract the cable. The control assembly 260 further operates the motor 250 and/or a brake or similar apparatus to restrict the cable from being extracted from a housing. The control assembly 260 is in wired or wireless communication with a terminal to receive a signal when an authorized user input, e.g., valid credentials/payment, is provided.

In the exemplary embodiment, the drive assembly includes at least one sensor to determine and/or control a position of a drive pulley 236 (shown in FIG. 12). As shown in FIGS. 9 and 10, the sensor may be an encoder 270 mounted on an axle or shaft of the drive pulley 236. During extraction or retraction of the cable, the encoder 270 records and sends electrical signals to the control assembly 260. The encoder 270 may provide data on the position, speed, and/or direction of the drive pulley 236, and in turn the cable. In some embodiments, the encoder 270 is an absolute encoder, i.e., providing an absolute position. The encoder may read the position by utilizing an optical, magnetic, or capacitive sensor to read a unique code off of an internal disc rotating within the axle or shaft 237 of the drive pulley 236. This code is translated and communicated as a specific position within the rotational movement.

The control assembly 260 may utilize the data from the encoder 270 to control the motor 250. For example, based on data from the encoder 270, the control assembly 260 may send a run signal to the motor 250 instructing it to travel in a given direction until a set length of travel is achieved, determined depending on the cable length being extracted/retracted. Once the travel is achieved, the control assembly 260 will remove the run signal to motor 250, disallowing the motor 250 to run further in the given direction.

Additionally, the control assembly 260 may use data from the encoder 270 for “slow” setpoints along the travel length. For example, once the travel reaches a defined distance away from the stop point in either direction, the control assembly 260 communicates with the motor 250 to reduce the travel speed to a slower velocity. This is a precautionary measure to ensure the user extracting/retracting the cable is aware that the control assembly 260 will stop the motor 250 in time in either direction of travel.

As shown in FIGS. 9 and 10, the sensor may also or alternatively be a proximity sensor 280 mounted on and extending through one of the frame members 240,242. Like the encoder 270, the proximity sensor 280 may provide data to determine and/or control the positioning of the cable through extraction and retraction. In the exemplary embodiment, the proximity sensor 280 is an inductive proximity sensor. The inductive proximity sensor operates by creating an electromagnetic field and monitoring a detection zone of the field. When a metallic object enters the vicinity and disturbs the magnetic field, the sensor turns on. Likewise, when the metallic object exits the detection zone of the field, the sensor turns off. Based on signals from the sensor, position, speed, and/or direction of the drive pulley 236, and in turn the cable, may be monitored. In other embodiments, the proximity sensor 280 may be, for example, an ultrasonic sensor, a photoelectric sensor, or a capacitive sensor. In some embodiments, the drive assembly includes both an encoder 270 and a proximity sensor 280. In other embodiments, the drive assembly includes only one of the encoder 270 or the proximity sensor 280.

FIG. 12 is an isometric view of the drive assembly shown in FIG. 9 with the frame member 240 removed. The drive assembly may include a guide 238 for the cable. The guide 238 includes a first portion 237 and a second portion 239 mounted between the frame members 240,242. Each of the first portion 237 and the second portion 239 have a groove for at least partially circumscribing a cable. The respective grooves together define an elongated channel for the cable. The guide 238 can be customized with different groove sizes, and/or the distance between the first portion 237 and the second portion 238 may be adjustable, to accommodate different cable sizes. In other embodiments, the idler pulley 138 as described above may be used instead of the guide 238. In such embodiments, pinch rollers 132 may be positioned at least partially around the idler pulley 138, e.g., as shown in FIG. 6.

When the proximity sensor 280 is used, the drive assembly includes a count plate 282 mounted adjacent to and/or coaxially with the drive pulley 236. The count plate 282 may be a disk (e.g., metallic disk) including a plurality of teeth 284 and notches 286 about its circumference. The count plate 282 is attached to the drive pulley 236 with a plurality of fasteners 288. In the exemplary embodiment, the count plate 282 is spaced apart from the drive pulley 236 with a gap therebetween.

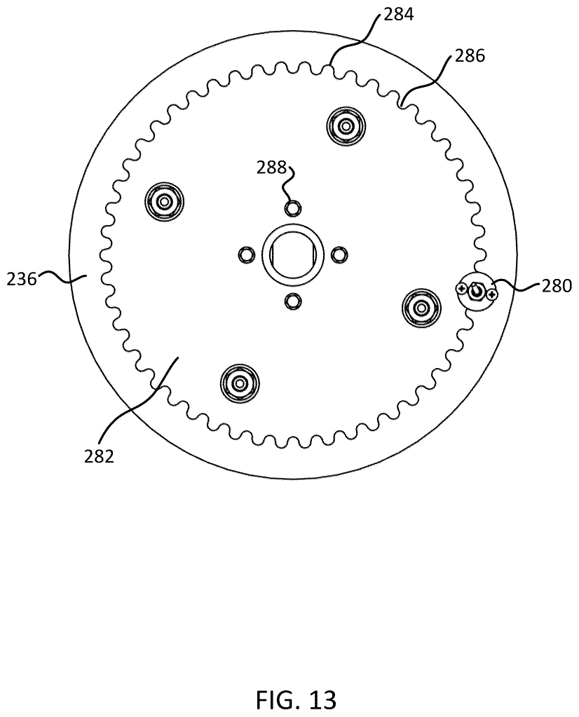

As shown in FIG. 13, the proximity sensor 280 is mounted along the circumference of the count plate 282. During travel of the drive pulley 236, the proximity sensor 280 sends data indicative of how many times the count plate 282 transitions from one state to another (i.e., notch to gap) to the control assembly 260. The control assembly 260 may send a run signal to the motor 250 instructing it to run in a given direction while the count value is below the designated travel distance. Calculating how much distance is traveled for a given number of counts, the control assembly 260 is able to use this method to get precise positional control required by the varying cable lengths. Once the travel is achieved, the control assembly 260 signal to motor 250, disallowing the motor 250 to run further in the given direction. Also, like the encoder 270, data from the position sensor 280 may be used for “slow” setpoints along the travel length, as discussed above.

As shown throughout the drawings, like reference numerals designate like or corresponding parts. While illustrative embodiments of the present disclosure have been described and illustrated above, it should be understood that these are exemplary of the disclosure and are not to be considered as limiting. Additions, deletions, substitutions, and other modifications can be made without departing from the spirit or scope of the present disclosure. Accordingly, the present disclosure is not to be considered as limited by the foregoing description.

What is claimed is:

1. A cable storage system, comprising:
a housing having a top portion, a bottom portion, and an opening;
a drive pulley within the top portion of the housing;
a cable at least partially contained in the housing having a proximal end in the top portion of the housing and a distal end outside of the housing, the cable extending over the drive pulley and through the opening; and
a motor driving the drive pulley to extend or retract the cable via the opening in response to a signal,
wherein the bottom portion of the housing is sized to permit the cable, in a retracted configuration, to hang in the bottom portion of the housing.

2. The system of claim 1, wherein the cable is an electric vehicle charging cable, the proximal end of the electric vehicle charging cable being attached to a power supply.

3. The system of claim 1, wherein the signal is indicative of a user validation.

4. The system of claim 3, wherein the user validation includes a validation of user credentials or a payment method.

5. The system of claim 1, further comprising a first frame member and a second frame member, wherein the drive pulley is rotatably secured between the first and second frame members.

6. The system of claim 5, wherein the motor is secured on an exterior of one of the first frame member or the second frame member.

7. The system of claim 5, wherein the housing includes a cable head pocket including the opening, wherein the cable head pocket is attached to the first and second frame members.

8. The system of claim 5, further comprising a plurality of pinch rollers adjacent to the drive pulley, wherein the cable extends between the plurality of pinch rollers and the drive pulley.

9. The system of claim 8, wherein each of the plurality of pinch rollers has an axle positioned in a first slot in the first frame member and a second slot in the second frame member, the axle being biased in a direction towards the drive pulley by a spring.

10. The system of claim 5, further comprising an idler pulley rotatably secured between the first and second frame members, wherein the cable extends at least partially around the idler pulley.

11. The system of claim 1, wherein the housing includes at least one panel with a vent.

12. A drive system for a cable, comprising:
a first frame member;
a second frame member;
a drive pulley rotatably secured between the first and second frame members and configured to receive the cable;
a plurality of pinch rollers rotatably secured between the first and second frame members adjacent to the drive pulley, each of the plurality of pinch rollers being spring-biased toward the drive pulley;
a motor attached to one of the first or second frame members for driving the drive pulley; and
a sensor for determining a position of the drive pulley.

13. The system of claim 12, wherein each of the plurality of pinch rollers has an axle positioned in a first slot in the first frame member and a second slot in the second frame member, the axle being biased in a direction towards the drive pulley by a spring.

14. The system of claim 12, wherein the sensor is an encoder on an axle of the drive pulley.

15. The system of claim 12, further comprising a count plate rotatable coaxially with the drive pulley, the count plate having a plurality of teeth about a circumference of the count plate, wherein the sensor is a proximity sensor mounted adjacent to the circumference of the count plate.

16. An electric vehicle charging system, comprising:
a terminal including a power supply and at least one input device for receiving input from a user; and
a cable storage system including a housing having a top portion, a bottom portion, and an opening; a drive pulley within the top portion of the housing; a charging cable at least partially contained in the housing having a proximal end attached to the power supply and a distal end outside of the housing, the charging cable extending over the drive pulley and through the opening; and a motor driving the drive pulley to extend or retract the charging cable via the opening in response to a signal from the terminal, wherein the bottom portion of the housing is sized to permit the charging cable, in a retracted configuration, to hang in the bottom portion of the housing.

17. The system of claim 16, wherein the input includes user credentials or a payment.

18. The system of claim 16, wherein the signal is indicative of a user validation.

19. The system of claim 16, wherein the cable storage system further comprises an idler pulley rotatably secured in the housing, wherein the idler pulley is positioned forward of the drive pulley in the housing, wherein the charging cable extends at least partially around the idler pulley.

20. The system of claim 19, wherein the cable storage system further comprises a first frame member and a second frame member, wherein the drive pulley and the idler pulley are rotatably secured between the first and second frame members.
